(19) United States
(12) Patent Application Publication
(10) Pub. No.: US 2002/0120464 A1
(43) Pub. Date: Aug. 29, 2002

(54) Computerized litigation and adjudication method and system

(76) Inventor: Teri A. Kirk, Ottawa (CA)

Correspondence Address: Teri A. Kirk, Suite 201, 24 Monkland Avenue, Ottawa, ON, K1S 1Y9, CA

(21) Appl. No.: 10/068,934

(22) Filed: Feb. 11, 2002

(30) Foreign Application Priority Data
Feb. 9, 2001 (CA) 2,335,422

(51) Int. Cl. G06F 17/60

(52) U.S. Cl. 705/1

(57) ABSTRACT

A method and computerized system for carrying out litigation, adjudicative processes, or the resolution of similar types of disputes, via the Internet, incorporating operation system software that enables 2 or more parties to such litigation, adjudicative process, or dispute, to prepare for such process in independent secure workrooms situate on dedicated Web sites and to meet with a resolution professional, such as a judge, adjudicator, or arbitrator, in a secure resolution room, also situate on a dedicated Web site, is disclosed. An 8-step method and computerized system providing an end-to-end alternative to commercial litigation and conventional arbitration and incorporating the following functionality is also disclosed:

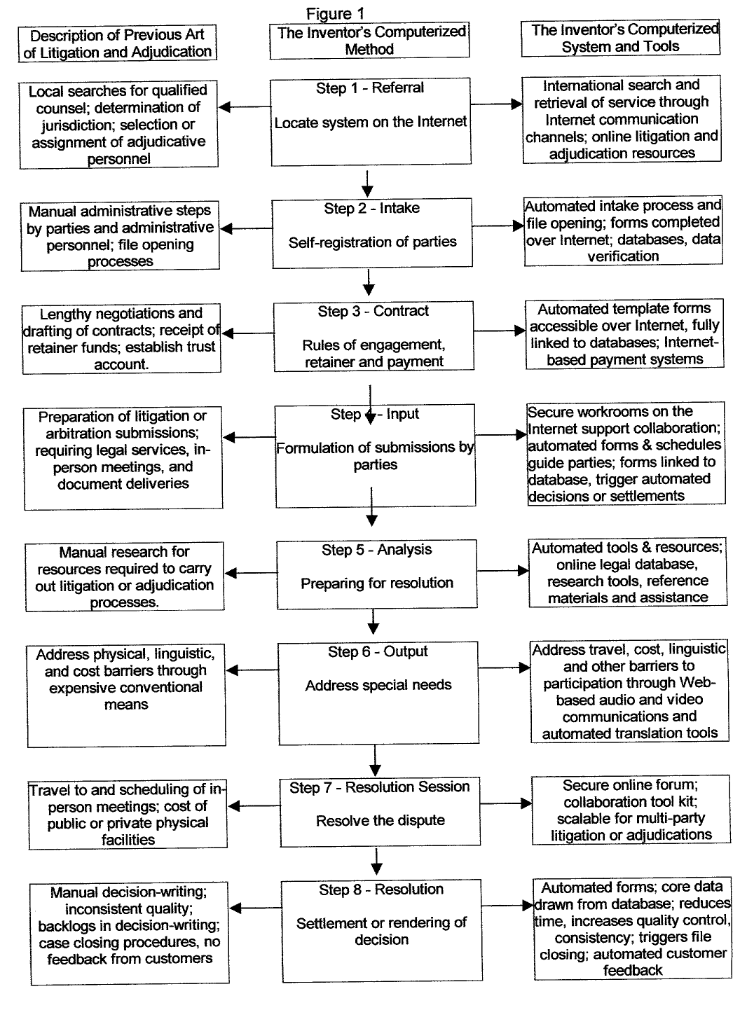

### CROSS-REFERENCE TO RELATED APPLICATIONS

There have been no related applications by the Applicant to the United States Patent and Trademark Office. The Applicant has made a prior foreign application, being application number 2,335,422, filed Feb. 11, 2001 in the Patent and Trademark Office of Canada. The Applicant and now makes this international application in respect of the same invention designating the United States of America.

There are 3 related applications by other inventors filed in the Office of the United States Patent and Trademark Office. They are:

6,330,551—Computerized Alternative Dispute Resolution System and Method

This patent relates to a “blind negotiation tool” used by Cybersettle to support direct party-to-party negotiations of monetary sums related to small consumer disputes. These tools are largely offered as “freeware” associated with B2C transactions. The patent does not disclose a computerized system for enabling litigation or public adjudicative processes.

2002001591—Automated Complaint Resolution System

This patent discloses a system for automating merchant consumer disputes that is not computer assisted and does not computerize litigation, hearings, and related adjudication processes.

6,343,271—Electronic Creation, Submission, Adjudication and Payment of Health Insurance Claims

This patent discloses a process to enable the filing and determination of claims related to health insurance coverage by insured persons to their health insurers and does not does not disclose a computerized method or system for carrying out litigation and related adjudication processes to resolve a broad range of subject matter or issues in dispute between 2 or more parties before independent judicial or adjudicative personnel

### STATEMENT REGARDING FEDERALLY SPONSORED RESEARCH AND DEVELOPMENT

The invention has received no subsidization or grants from the federal government of the United States and there are no rights to the invention that have been granted or assigned to or made under federally sponsored research and development.

### REFERENCE TO A SEQUENCE LISTING OR OTHER APPENDIX

Not Applicable

### BACKGROUND OF THE INVENTION

The application is filed under Class 705—Methods of data processing in respect of business practices and management, computer-implemented processes relating to e-commerce and the Internet. The invention relates to the fields of law, courts, judicial and public administration, information technology, and e-commerce. In particular, the invention arises out of the Global Business Dialogue on e-Commerce (GBD-e), hosted by the Organization for Economic Cooperation and Development (OECD) in or about 1999, which concluded that public court systems were too slow, and too expensive and judgments too hard to enforce—what was needed to support today's fast-paced technology-enabled and global economy was a fast affordable alternative.

The inventor combines years of professional practice as a lawyer appearing before the courts, with formal education and experience managing the introduction of technology-enabled solutions into the justice system. The inventor worked as a senior business development executive within one of North America's largest telecommunications consortia developing telecommunications-based solutions for justice, and related public services. The inventor invented the Computerized Litigation and Adjudication Method and System and incorporated the Applicant corporation for the purpose of commercializing the invention as The Electronic Courthouse™.

The problem being solved by the invention is the enormous time, costs, and complexities of commercial litigation and related adjudicative processes, particularly for parties in diverse locations or jurisdictions. Businesses in Europe and North America spend $38B annually on legal fees for commercial litigation. By 2004, B2B e-commerce in North America is expected to exceed $2.7 Trillion annually. The Method and System greatly reduces the time, the cost, and the complexity of resolving the commercial disputes that inevitably arise for businesses that are participating in e-commerce or otherwise buying and selling, and exporting and importing, products and services in a multi-jurisdictional environment. For these companies whether small, medium or large enterprises—issuing statements of claim in justice systems around the world, with the inherent questions of fairness and impartiality, timeliness and cost, compliance and enforceability, is largely prohibitive and seldom a viable solution. In many instances, legitimate claims by these businesses are simply not pursued and the funds are lost. The Computerized Litigation and Adjudication Method and System is a fast, affordable, and reliable system for pursuing rights of recourse in order to promote and facilitate international trade and e-commerce and a vibrant domestic and international export market.

Similarly, attendance before public adjudicative bodies, such as human rights commissions and property tax assessment review boards, require filing of diverse forms in paper format and in-person attendances before adjudicative personnel at great cost and inconvenience to the parties and to governments seeking to deliver such important adjudicative processes in an equitable and efficient manner.

The useful and practical result of the Invention is to reduce the overall time for completion of litigation or related adjudicative processes by as much as 99%, from an average of approximately 600 days to complete litigation in most jurisdictions in North America to a guaranteed service delivery time of 72 hours, and to reduce the overall cost to the parties, from an average of approximately $25,000 per party to complete litigation in most jurisdictions in North America to a fixed price in the range of $2500 per party.

Within the B2B marketplace, the opportunity for conflict and the need for rapid resolution has never been greater, given the fast-paced, rapidly changing, global environment, in which businesses have limited experience and the law remains uncertain. The last 5 years have produced rapid expansion in the demand for alternatives to litigation. Virtually unheard of only a decade ago, 10% of commercial litigation fees—3.6B annually—are now spent on alternatives to litigation. As the number of businesses transacting online continues to rapidly expand (55% annual growth among American small businesses), the Computerized Litigation and Adjudication Method and System delivers a comprehensive computerized method and system that allows businesses to comply with these market demands and emerging compliance standards.

Similarly, the Computerized Litigation and Adjudication Method and System can be used by courts and public adjudicative bodies to facilitate regulated filings and attendances before such bodies from home communities through automated systems and providing improved access to related resources, allowing governments to use available technologies to deliver these important rights of recourse to citizens in an equitable and efficient manner.

### BRIEF SUMMARY OF THE INVENTION

The invention provides a method and computerized system for carrying out litigation, adjudicative processes, or the resolution of similar types of disputes, via the Internet. It incorporates operation system software that enables 2 or more parties to the litigation, adjudicative process or dispute, such as importers, exporters, manufactures and other businesses or their employees, partners, customers, suppliers and consumers, to independently prepare for such processes in independent secure workrooms situate on dedicated Web sites and to meet with a resolution professional, such as a judge, adjudicator, or arbitrator, in a secure resolution room, also situate on a dedicated Web site. The invention employs an 8-step method and computerized systems to provide an end-to-end alternative to commercial litigation and conventional arbitration.

### DETAILED DESCRIPTION OF THE INVENTION

A method and computerized system for carrying out litigation, adjudicative processes, or the resolution of similar types of dispute, via the Internet, incorporating operation system software that enables 2 or more parties to such litigation, adjudicative process, or dispute, to prepare for such process in independent secure workrooms situate on dedicated Web sites and to meet with a resolution professional, such as a judge, adjudicator, or arbitrator, in a secure resolution room, also situate on a dedicated Web site. The method consists of an 8-step methodology, backed by a computerized system, incorporating the following 8 steps:

Step 1—facilitates the location of the System on the Internet, through automated linkages with portals, search engines, and other Internet-based communications channels (“Referral”),

Step 2—enables the registration of the parties in the System by the entry of data into automated forms that triggers the opening of files and selection of Resolution Professionals in accordance with pre-determined criteria (“Intake”),

Step 3—facilitates the execution of Rules of Engagement and retainer, and payment through Internet-based payment systems (“Contract”),

Step 4—provides secure client workrooms where the parties may collaborate with select colleagues, agents, or advisors, and formulate submissions through automated forms rendered scalable through the use of data-generated schedules (“Input”),

Step 5—delivers a suite of automated online tools including database of over 70,000 answers to commonly asked legal questions, (“Analysis”),

Step 6—enables customization of the process to address special needs through Web-enabled tools such as multi-lingual automated document and oral translation systems (“Output”),

Step 7—provides a secure online forum and Online Collaboration Tool Kit to support multiple users making oral and written submissions and filing supporting documentation while carrying out collaborative document drafting and editing, white-boarding, voice communications, and messaging across the Internet, supplemented by secure “side rooms” to support independent consultation (“Resolution Session”), and

Step 8—enables the rendering of decisions by Resolution Professionals in a consistent automated format with key data fields pre-populated by the parties' own data, and facilitates customer feedback and continuous System improvement through automated Exit Survey forms that aggregate and anonymize the data (“Resolution”).

1: The Applicant claims as its invention a computerized method and computerized system for carrying out litigation, adjudicative processes, and the resolution of similar types of disputes, via the Internet, incorporating operation system software that enables 2 or more parties to such litigation, adjudicative process, or dispute, to prepare for such process in independent secure workrooms situate on dedicated Web sites and to meet with a resolution professional, such as a judge, adjudicator, or arbitrator, in a secure resolution room, also situate on a dedicated Web site, providing an end-to-end alternative to commercial litigation and conventional arbitration, and incorporating the following 8-step method and computerized functionality:
Step 1 facilitates the location of the System on the Internet, through automated linkages with portals, search engines, and other Internet-based communications channels as an alternative to the assignment of judicial personnel through local justice systems or the selection of arbitrators through local referral agencies (“Referral”),
Step 2 enables the registration of the parties in the System by the entry of data by the parties themselves into automated forms, which triggers the opening of files and selection of Resolution Professionals in accordance with pre-determined criteria, replacing numerous administrative steps by the parties and administrative personnel (“Intake”),
Step 3 facilitates the execution of Rules of Engagement and retainer, and payment through Internet-based payment systems, replacing lengthy negotiations among the parties and eliminating payment risks (“Contract”),
Step 4 provides secure client workrooms where the parties may collaborate with select colleagues, agents, or advisors, and formulate submissions through automated forms rendered scalable through the use of data-generated schedules, greatly reducing the time and resources associated with preparing, organizing, communicating and formatting draft and final submissions, and the costs associated with in-person meetings and sharing of paper documentation through conventional delivery and collaboration systems “Input”),
Step 5 delivers a suite of applicable automated tools and resources including a database of over 70,000 answers to commonly asked legal questions, greatly reducing the time and costs associated with accessing such articles, books, information, research and resources associated with participating in litigation, adjudicative processes, or disputes (“Analysis”),
Step 6 enables customization of the process to address special needs of a party or parties through Web-enabled tools such as multi-lingual automated document and oral translation systems, replacing expensive and time-consuming conventional translation systems required to support litigation, adjudicative processes, and the resolution of disputes (“Output”),
Step 7 provides a secure online forum and Online Collaboration Tool Kit to support multiple users making oral and written submissions and filing supporting documentation while carrying out collaborative document drafting and editing, white-boarding, voice communications, and messaging across the Internet, supplemented by secure “side rooms” to support independent consultation, replacing the need for parties and their agents, team members, and witnesses to travel to in-person meetings, to secure facilities at considerable cost to the parties or to public justice service providers, and to secure conventional alternatives to such tools (“Resolution Session”), and
Step 8 enables the rendering of decisions by Resolution Professionals in a consistent automated format with key data fields pre-populated by the parties' own data, and facilitates customer feedback and continuous System improvement through automated Exit Survey forms that aggregate and anonymize the data, greatly reducing the time required by adjudicative personnel to complete this process, introducing consistency and quality control, where desired, among resolution professionals, and facilitating customer feedback and inputs into such litigation and adjudicative processes (“Resolution”).
